(19) United States
(12) Patent Application Publication
(10) Pub. No.: US 2024/0209836 A1
(43) Pub. Date: Jun. 27, 2024

(54) CONTROL SCHEME FOR CLUSTER OF WIND TURBINES

(71) Applicant: VESTAS WIND SYSTEMS A/S, Aarhus N (DK)

(72) Inventor: Mahmood MIRZAEI, Skovlunde (DK)

(21) Appl. No.: 18/557,544

(22) PCT Filed: Apr. 25, 2022
(86) PCT No.: PCT/DK2022/050083

§ 371 Date: Oct. 26, 2023

(30) Foreign Application Priority Data
Apr. 27, 2021 (DK) PA 2021 70189

(51) Int. Cl. F03D 7/04

(52) U.S. Cl. CPC F03D 7/049; F05B 2270/204; F05B 2270/32

(57) ABSTRACT

A method for controlling a first wind turbine cluster to improve wake recovery of the wind that flows through that cluster, which may therefore improve the consistency of air flow for a downstream cluster of wind turbines. The method comprises quantifying a wake effect of the first wind turbine cluster on the operational performance of a second wind turbine cluster, identifying a triggering condition based on the quantified wake effect, and, in response, controlling one or more operational parameters of the wind turbines in the first wind turbine cluster to improve the wake recovery of the first wind turbine cluster.

### TECHNICAL FIELD

The invention relates to control regimes for clusters of wind turbines, in particular to improve efficiency of power production.

### BACKGROUND

Typically wind turbines are grouped together into clusters of wind turbines. These clusters may also be considered to be separate wind power plants or “wind farms” in some circumstances. Typically wind turbines are grouped into tens of individual wind turbines to form such a cluster or power plant. The power outputs of wind turbines in a given cluster are usually coupled to a point of common connection which is connected to a larger energy distribution grid.

A common approach is for each of the individual wind turbines within a wind power plant to operate under a control regime which focuses on maximising the power output of that wind turbine, based on localised factors such as wind speed, demanded power output, and fatigue limits. Based on the determined maximum power output, a control module of each wind turbine controls the operation of various turbine components, such as the generator/power converter, the pitch system, the brakes, and the yaw mechanism to reach the maximum power efficiency. It is known also to factor in turbine-to-turbine interactions in optimising the performance of a wind turbine. For example, a wind turbine that is downwind of another may experience a wake effects caused by the upwind turbine, tending to reduce wind speed and increase turbulence. Therefore, pursuing maximum efficiency of all wind turbines may lead to sub-optimal performance and/or reliability of other wind turbines in the wind farm.

Various approaches are known in the art which attempt to optimise the performance of a wind power plant by taking into account the effect that neighbouring wind turbines have on each other. However, with the increased penetration of wind power into the world's energy supply, and the steadily increasing density of wind power installations, a broader consideration is required as to the interaction between wind turbines so as to optimise performance and maximise energy generation efficiency. It is against this background that the invention has been devised.

### SUMMARY OF THE INVENTION

According to an aspect of the present invention there is provided a method for controlling a first wind turbine cluster to improve wake recovery of the wind that flows through that cluster, which may therefore improve the consistency of air flow for a downstream cluster of wind turbines. The method comprises quantifying a wake effect of the first wind turbine cluster on the operational performance of a second wind turbine cluster, identifying a triggering condition based on the quantified wake effect, and, in response, controlling one or more operational parameters of the wind turbines in the first wind turbine cluster so as to improve the wake recovery of the first wind turbine cluster.

The invention embraces a controller for a cluster of wind turbines, wherein the controller is configured carry out the method as defined above, and also to a computer program product, and also to a data carrier, comprising instructions which, when executed by a computer, cause the computer to perform the method as defined above.

Advantageously, improving the wake recovery of the first wind turbine cluster reduces the wake effect of the first wind turbine cluster on the second wind turbine cluster.

The step of quantifying the wake effect may be a step of determining a severity of the wake effect.

In one embodiment, the step of quantifying the wake effect includes determining a difference in wind speed between a wind speed position upstream of the first wind turbine cluster and a wind speed position upstream of the second wind turbine cluster. The difference in wind speed therefore provides a useful evaluation of the wind speed that is ‘lost’ between the first wind turbine cluster and the downstream second wind turbine cluster.

The step of quantifying the wake effect may also include determining the turbulence of the wind flow upstream of the second wind turbine cluster. Determination of the wind turbulence may be as an alternative or in addition to determining the wind speed difference between the first and second wind turbine clusters. Basing the determination of the wake severity on just the turbulence of the wind upstream of the second wind turbine cluster may provide for a simplified sensing system.

The step of quantifying the wake effect may also include modelling the wake effect of the first wind turbine cluster on the second wind turbine cluster based on one or more wind flow conditions associated with the first wind turbine cluster. Beneficially, modelling the wake effect means that direct sensing of wind flow conditions may not be needed.

The triggering condition is identified based on the quantified wake effect, and generally a triggering condition may be identified if the wake severity exceeds an acceptable level. For example, a triggering condition may be identified if a difference in wind speed between a wind speed position upstream of the first wind turbine cluster and a wind speed position upstream of the second wind turbine cluster is larger than a specified level. For example, the triggering condition may be taken as a difference of a specified percentage being observed over a specified time period, such as a wind speed reduction above 10% over 10 minutes. In another example, the triggering condition may be identified as a turbulence level being above a specified level. Turbulence may be measured in different ways, and the skilled person may set an appropriate level based on a selected turbulence measure. In another example, the triggering condition may be identified based on a modelling of the wake effect. In such a model, a wake measure may be defined and a level above which the triggering condition should be identified can be set.

The one or more operational parameters may include a yaw angle setpoint and an induction factor setpoint. The one or more operational parameters may be configured so that they vary dynamically, which may improve wake recovery. In one embodiment, the one or more dynamically changing operational parameters are applied by way of a periodically oscillating signal, which may be sinusoidal, for example, to respective wind turbines in the first wind turbine cluster, but other time-varying signals are also appropriate. The oscillating signals may be applied in a coordinated way to the wind turbines, which may take the form of the sinusoidal signals for respective wind turbines being out of phase with one another by a predetermined amount.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic view of two neighbouring wind power plants or ‘clusters’, illustrating how the wake from a first of the wind turbine clusters can affect the operation of the second wind turbine cluster;

FIG. 2 is a schematic view of two neighbouring wind turbine clusters, similar to the layout shown in FIG. 1, but which depicts a control system in accordance with an embodiment of the invention;

FIG. 3 represents two time series plots of a control setpoint against time, each plot representing a signal sent to a different wind turbine in a cluster;

FIG. 4 is a schematic diagram of a power plant controller in accordance with an embodiment of the invention; and

FIG. 5 is a flow chart illustrating a method in accordance with an embodiment of the invention.

### DETAILED DESCRIPTION

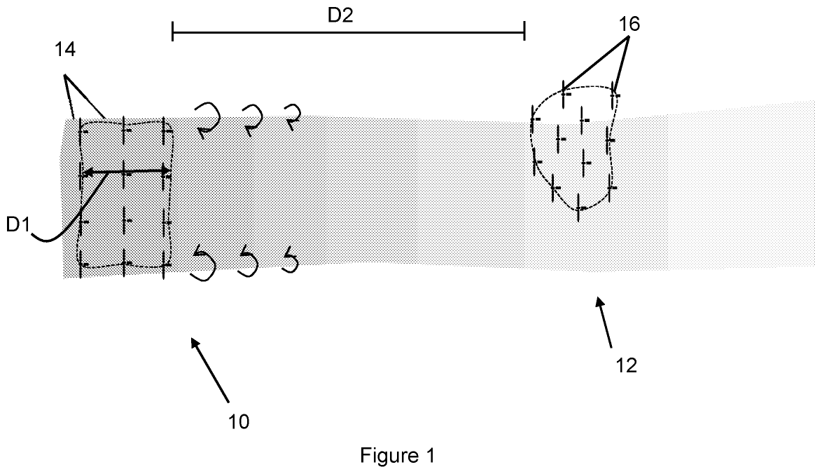

With reference to FIG. 1, a first wind turbine cluster 10 is shown near to but separated from a second wind turbine cluster 12.

Each of the wind turbine clusters 10,12 include a plurality of wind turbines. Here, the first wind turbine cluster 10 includes twelve individual wind turbines 14, and the second wind turbine cluster 12 includes eleven wind turbines 16. It should be appreciated that this is just exemplary, and a wind turbine cluster may in principle include any number of wind turbines. Typically, however, wind turbines are grouped into clusters of between five and many tens of wind turbines.

A wind turbine cluster may be considered to be a wind power plant. Typically, separate wind power plants are owned and operated by different businesses and have different electrical connections to a wider distribution grid. So, in this context a wind turbine “cluster” as defined here embraces a wind power plant or ‘wind farm’ in the commonly used sense. Conversely, however, a wind power plant that is owned and managed by a single operator may include more than one wind turbine cluster due to the spacing between wind turbines. In either of these contexts, a cluster of wind turbines will be embodied as a collection of wind turbines that have a common communication structure which allows for coordinated control of those wind turbines in the assigned cluster. That assignment to the cluster may be determined on a predefined assignment based on empirical studies and/or may be based on geometric considerations about the layout of the wind turbines that make up a cluster.

Typically, a wind turbine cluster will be a group of wind turbines that are closer together than another group of wind turbines. A wind turbine ‘cluster’ may therefore be defined by the separation distance between one cluster and another as compared to a ‘characteristic’ cluster size. The characteristic cluster size may be defined in various ways. In one example, the characteristic cluster size can be considered to be the maximum separation between any two wind turbines in the first cluster when measured in the same direction as the distance between two neighbouring clusters. This is explained visually with reference to FIG. 1. Here, the maximum separation distance between two turbines in the first wind turbine cluster 10 is illustrated as D1, and the distance D1 is aligned with, and so is taken in the same direction as, the distance D2 which is the distance between the two clusters 10,12.

In terms of identifying what makes a ‘cluster’, in general a wind turbine cluster is defined visually by an area that is circumscribed by an outermost ring of wind turbines, which are shown here by dotted lines that pass through each nacelle. Distance D2 may be taken from the closest/nearest two points between the clusters, as is shown here. Alternatively, the distance between clusters may be taken from a datum point defined by a geometric centre or ‘centroid’ of each cluster. It should be noted that the determination of the planform shape of a cluster and the determination of a geometric centre would be within the ambit of a skilled person.

It will be noticed here that the distance D1 can be considered to be an approximation of the ‘size’ of the cluster. Of course, wind turbines within clusters may be arranged in other layouts other than rectangular. Indeed, it is known for wind turbines to be configured in layouts that appear to be irregular to the eye, but are in fact dictated by predominant wind flows, terrain features and other factors. Indeed, some clusters of wind turbines may be arranged in a relatively ‘rounded’ pattern as shown in FIG. 1, but it is also possible for wind turbines to arranged in more linear configurations, for example twenty wind turbines arranged in two rows of ten. Rather than the cluster size being defined by the maximum distance between any two wind turbines in that cluster in a direction aligned with the direction between clusters, the characteristic cluster size may be defined in other ways, for example as the average of the sum of separation distances between wind turbines located on the perimeter of the cluster, or the maximum distance between points on the perimeter of the cluster, when taken through the geometric centre of the cluster.

As can be seen in FIG. 1, the second wind turbine cluster 12 is spaced a significant distance from the first wind turbine cluster 10, and this is marked as D2. In the layout shown in FIG. 1, the distance D2 between the clusters is approximately three times as great as the distance D1. Although the separation between clusters is shown here as about three times the ‘characteristic size’ of the first wind turbine cluster 10, in practice the separation between clusters can be greater than this.

It is necessary to space apart clusters of wind turbines in order to provide a sufficient distance for the wake of one cluster of wind turbines to dissipate or ‘recover’ before the flow of wind reaches a downstream cluster of wind turbines. However, wake effects are problematic to quantify, and it may be the case that a cluster of wind turbines downstream from another cluster is still affected by wake effects on the flow of wind, despite a significant separation between the wind turbine clusters. This is illustrated in FIG. 1, in which the wake effects of the first wind turbine cluster 10 are reduced, but still present, in the wind flow that is incident on the second wind turbine cluster 12. Therefore, the wind turbines in the second wind turbine cluster 12 would experience a reduced average wind speed compared to the first wind turbine cluster 10 and increased air flow turbulence, both factors reducing the energy generation potential of the second wind turbine cluster 12.

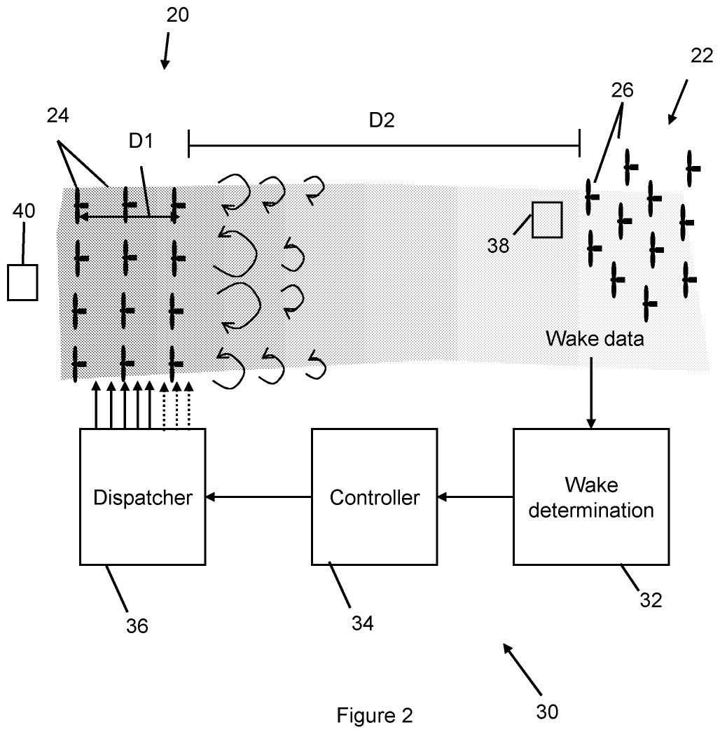

The embodiments of the invention provide an approach to mitigating this issue. With reference to FIG. 2, a wind turbine layout is illustrated similar to that shown in FIG. 1 and comprises a first wind turbine cluster 20 and a second wind turbine cluster 22. Each of the clusters 20,22 comprises a plurality of wind turbines 24,26. The first and second wind turbine clusters 24, 26 are spaced apart from each other by a distance D2, which is greater than the maximum turbine distance D1 in the first wind turbine cluster 24.

Notably, in FIG. 2 the second wind turbine cluster 22 is separated from the first wind turbine cluster 20 by a distance that is preferably greater than 150% of the maximum separation distance D1, and preferably more than 200% of the maximum separation distance D1.

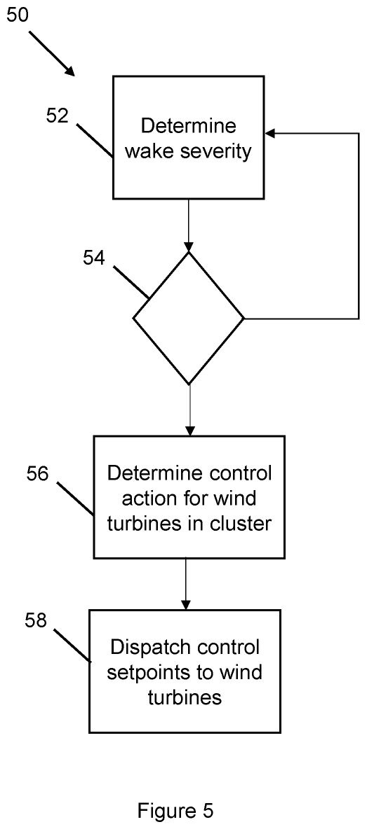

The invention includes a control system 30 that is configured to quantify the wake effect of the first wind turbine cluster 20 on the operational performance of the second wind turbine cluster 22. The control system 30 is further configured to apply a mitigating control action to at least some the wind turbines in the first turbine cluster 20 so as to improve the wake recovery of the first wind turbine cluster thereby to reduce the wake effect on the second wind turbine cluster 22. The operation of the control system 30 will now be described with further reference to FIG. 2, and also with reference to the flow chart of FIG. 5.

In overview, the control system 30 includes a wake determination module 32, a controller 34 that is configured to be responsive to the output of the wake determination module 32, and a dispatcher 36 that is configured to communicate with at least some of the wind turbines in the first wind turbine cluster 20.

The wake determination module 32 is configured to determine the severity of the wake effect generated by the operation of the first wind turbine cluster 20. The wake determination module 32 is also configured to determine whether the severity of the wake influence on the second wind turbine cluster 22 requires an intervention on the operation of the first wind turbine cluster 20. This process is reflected by steps 52 and 54 of the algorithm 50 in FIG. 5 in which the wake is firstly measured and quantified at step 52, and then evaluated as being within acceptable limits at step 54. If the wake effect experienced by the second wind turbine cluster is within acceptable limits, the process 50 may loop until the wake effects are serious enough for action to be required.

Various methods may be used to achieve this functionality, and some examples will be described here. Other examples would be apparent to the skilled person. In the illustrated embodiment, the wake determination module 32 receives a wake data input. The wake data input is provided in the illustrated embodiment from a first wind sensor 38 and a second wind sensor 40. The wake data input provides the wake determination module 32 with suitable information about the wind flow experienced by the second wind turbine cluster 22, optionally with reference to the first wind turbine cluster 20. It will be noted that the first wind sensor 38 is located at a position upstream of the second wind turbine cluster 22 and therefore downstream of the first wind turbine cluster 20, when considered in the direction of the wind flow from the first to the second wind turbine clusters 20,22.

In one exemplary method, it is envisaged that wake severity may be evaluated by quantifying the turbulence of the wind flow. Wind flow turbulence will be detected if the first wind sensor 38 indicates rapid fluctuations in wind velocity that exceed a predetermined value. Although turbulence may be assessed at a single sensing point, a more reliable indication may be achieved by assessing wind speed at multiple points across the wind field in front of the second wind turbine cluster 22.

In another embodiment, the severity of the wake at the second wind turbine cluster 22 may be evaluated by comparing the wind speed upstream of the second wind turbine cluster 22 to the wind speed at a position upstream of the first wind turbine cluster 20, as indicated by the second wind sensor 40. The severity of the wake from the first wind turbine cluster 20 may therefore be quantified by evaluating the difference in wind speeds measured by the first wind speed sensor 38 and the second wind speed sensor 40. If the wind speed difference is greater than a predetermined value, this indicates that the wake has not sufficiently recovered and in the influence of the first wind turbine cluster 20 on the second wind turbine cluster 22 is unacceptably high. The difference in wind speed between the two clusters could also be combined with evaluation of the wind flow turbulence to determine the severity of the wake effect at the second wind turbine cluster 22.

In a further approach, it is envisaged that a computerised modelling process may be used to quantify the wake effect on the second wind turbine cluster 22. The modelling process may be based on one or more wind flow conditions relating to the first wind turbine cluster 20 that are measured or otherwise determined. The wind flow conditions may include wind speed, wind velocity, wind direction, wind shear, turbulence level to name a few examples. The values could be measured directly from appropriate sensing systems such as the wind sensors 38,40 or from meteorological masts installed near to the wind turbine clusters, or the wind flow conditions could be derived from global weather models. Following a period of measuring relevant data, a data-driven modelling technique may be adopted in which the data of the flow conditions may then have a model fitted to it. The model can then be used to detect wake conditions in the future.

In whichever method the wake severity is evaluated, the wake determination module 32 is operable to identify a triggering condition if the wake severity exceeds an acceptable level. This is illustrated at step 54 in FIG. 5.

Once a triggering condition is identified, the control system 30 is operable to take corrective action to improve the wake recovery and thereby reduce the negative influence of the wake on the second wind turbine cluster 22, as shown at step 56 in FIG. 5. To this end, the controller 34 is operable to provide an output to the dispatcher 36 in response to the identification of a triggering condition in order to improve the wake recovery. In turn, the dispatcher 36 sends appropriate control signals to at least some of the wind turbines in the first wind turbine cluster 20, as indicated at step 58 in FIG. 5.

It is envisaged that important control parameters that may be used to affect the wake recovery are the induction factor or thrust of the wind turbines in the cluster, for example by changing the collective pitch angle of the turbine, and also the yaw angle of the wind turbines. The controller 34 may therefore be configured to adjust one or both control parameters in response to a triggering condition being identified. Other options for the control parameters that may be changed is the tip speed ratio and yaw heading. For example, in order to achieve a change in thrust magnitude, the tip speed ratio may be modified by changing the generator torque or power reference. Similarly, for changing the thrust direction, the heading of the wind turbine may be controller, e.g. by introducing a yaw error setpoint or individual pitch control to the blades could be applied.

With this in mind, therefore, the controller 34 is operable to generate suitable setpoints in respect of the wind turbines in the cluster 20 that are intended to improve wake recovery. The setpoints generated by the controller 34 are dispatched to the individual wind turbines in the cluster and therefore provide setpoint contributions to the internal yaw angle and induction factor settings that may be generated by the internal control processes of the wind turbines. The magnitude of the setpoints may be adjusted based on the severity of the wake effect. Therefore, wake effects that are only marginally above a threshold level may trigger comparatively low value setpoints, which may be implemented with a gain of less than 1. More severe wake effects may trigger higher setpoint values in response, which may be implemented with a gain of 1, or more than 1.

The value of the setpoints that are generated by the controller 34 may be static or dynamic. For example, one control action that the controller 34 may take is to apply a yaw angle setpoint contribution of 5 degrees for example, as either a clockwise or anticlockwise rotation. This static application of control setpoints may be achieved by way of a lookup table or similar data structure which is populated with control setpoint values that are to be applied following the identification of a triggering condition. The controller 34 is then operable to fetch the relevant control setpoints and transmit these to the dispatcher 36 which is operable to transmit the control setpoints to the individual wind turbines in the cluster 20. In this way, the control setpoints are generated to control the wind turbines in the cluster 20 in a coordinated way in response to the detection of an unacceptable wake condition.

In one embodiment, the controller 34 may be updatable such that the contents of the data structure can be changed so as to vary the response of the controller 34. This enables the control system 30 to be adapted to improve its behavioural response on detection of an unacceptable wake condition. Such a data update may be carried out by a suitably trained technician.

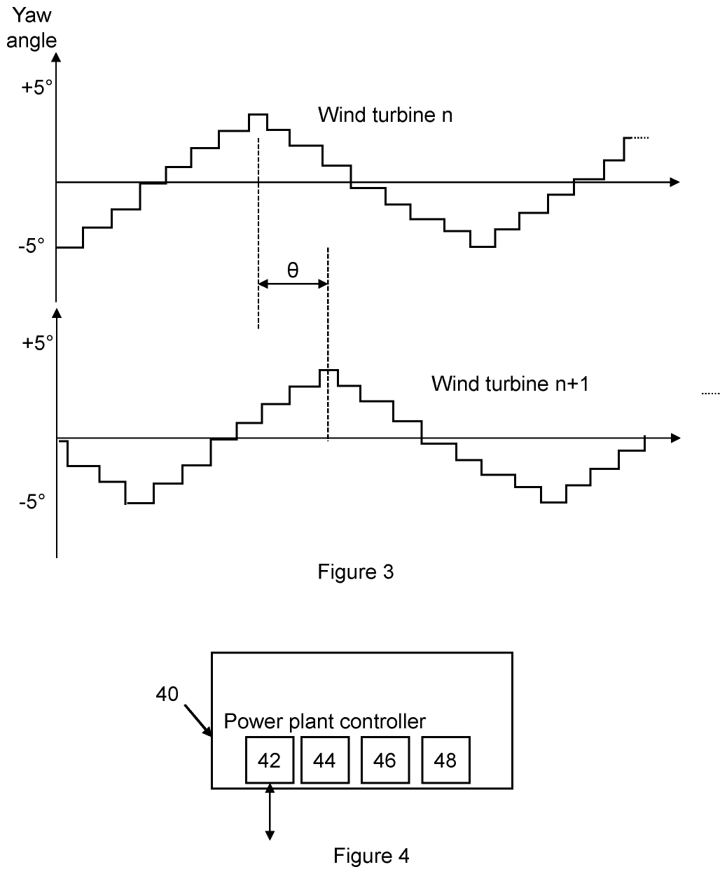

In another example, the controller 34 may apply the control setpoints to the individual wind turbines in a dynamic way, such that the control setpoints vary over time. One example of this can be explained by considering a single wind turbine in the cluster 20. The controller 34 may be configured to generate a control setpoint in respect of a particular wind turbine in the cluster which varies in an undulating manner, for example in the general form of a sinusoidal signal. An example of this is shown in FIG. 3, where the yaw angle setpoint in respect of wind turbine ‘n’ is varied in discrete steps between −5 degrees and +5 degrees. It will be appreciated that the effect of this is that the wind turbine that receives this setpoint signal will oscillate periodically about its prevailing yaw angle heading that is set by its internal control system. It should be noted that although the illustrated is a sinusoidally oscillating signal, other forms of periodically oscillating signal will be acceptable.

The same control setpoint signal may also be transmitted to other wind turbines in the cluster and in this way the wind turbines are controlled in a coordinated way to improve wake mixing. The control setpoints sent to different wind turbines in the cluster may be substantially identical, but it is envisaged that improved wake recovery will be achieved if the control setpoint signals sent to different wind turbines are different to one another so as to modulate the action of the wind turbines in the cluster. One way in which this may be achieved is shown in FIG. 3, in which wind turbine ‘n’ and wind turbine ‘n+1’ both receive similar sinusoidal yaw angle setpoint modulation signals, but which have a phase difference between the signals. Here, the illustrated phase difference 0 is between about 50 and 60 degrees.

The control setpoint signals may be suitably adjusted from wind turbine to wind turbine so that the phase difference increases. For example, there may be a 10 degree phase difference between the setpoint signals when considered between successive wind turbines in the cluster.

In the above discussion, the control setpoints are generated and applied to the wind turbines in an open loop process. However, it should be appreciated that the control system 30 may also be configured to generate the control setpoints as part of a closed loop control algorithm, by which means the characteristics of the control setpoints may be varied based on the error between the measured wake effect and the desired wake effect.

In the above discussion, the control system 30 is shown as being embodied by a series of separate functional modules, namely the wake determination module 32, the controller 34 and the dispatcher 36. However, this representation is for convenience of illustration and so it should be appreciated that the functionality represented by the modules and functional blocks in this discussion may be implemented separately or in combination as appropriate, and in hardware or software. As such, the functionality may be implemented in discrete and separated processing environments, or that functionality may be incorporated into a single processing environment.

It should be noted that the functionality of the control system 30 could be implemented in any suitable computing environment. One such environment would be the processing capabilities provided by a wind power plant controller of ‘PPC’. Such a power plant controller is a standard central control authority within a wind power plant and could be readily adapted to facilitate the processing requirements of the method described above. A schematic view of such a power plant controller 40 is shown in FIG. 4, and includes a processor 42, an input/output system 44, a volatile memory module 46 and a non-volatile memory module 48.

As an alternative, it is envisaged that one of the wind turbines in the first wind turbine cluster 20 could provide a suitable computing environment for carrying out the method according to the invention by virtue of an on-board wind turbine controller, which could be configured appropriately to communicate to the other wind turbines in its cluster for the transmission of the control setpoints.

It will be appreciated that various changes and modifications can be made to the present invention without departing from the scope of the present application.

1. A method for controlling a first wind turbine cluster, comprising:
quantifying a wake effect of the first wind turbine cluster on the operational performance of a second wind turbine cluster,
identifying a triggering condition based on the quantified wake effect, and, in response, controlling one or more operational parameters of the wind turbines in the first wind turbine cluster to improve the wake recovery of the first wind turbine cluster, thereby to reduce the wake effect of the first wind turbine cluster on the second wind turbine cluster.

2. The method of claim 1, where the first wind turbine cluster has a characteristic cluster size, which is a maximum distance between any two wind turbines in the first wind turbine cluster when taken in a direction that is aligned with the direction between first and second wind turbine clusters.

3. The method of claim 2, wherein the second wind turbine cluster is separated from the first wind turbine cluster by a distance that is greater than a maximum turbine separation distance, preferably greater than 150% of the maximum separation distance, and preferably more than 200% of the maximum separation distance.

4. The method of claim 1, wherein quantifying the wake effect includes determining a difference in wind speed between a wind speed position upstream of the first wind turbine cluster and a wind speed position upstream of the second wind turbine cluster.

5. The method of claim 1, wherein quantifying the wake effect includes determining the turbulence of the wind flow upstream of the second wind turbine cluster.

6. The method of claim 1, wherein the step of quantifying the wake effect includes modelling the wake effect of the first wind turbine cluster on the second wind turbine cluster based on one or more wind flow conditions associated with the first wind turbine cluster.

7. The method of claim 1, wherein the one or more operational parameters include a yaw angle setpoint.

8. The method of claim 1, wherein the one or more operational parameters include an induction factor setpoint.

9. The method of claim 1, wherein the one or more operational parameters are dynamically varying.

10. The method of claim 9, wherein the one or more dynamically changing operational parameters are applied by way of a periodically oscillating signal to respective wind turbines in the first wind turbine cluster.

11. The method of claim 10, wherein the respective periodically oscillating signals applied to neighbouring wind turbines are out of phase to one another.

12. A controller for a cluster of wind turbines, wherein the controller is configured to:
quantify a wake effect of a first wind turbine cluster on the operational performance of a second wind turbine cluster,
identify a triggering condition based on the quantified wake effect, and, in response, to control one or more operational parameters of the wind turbines in the first wind turbine cluster so as to improve the wake recovery of the first wind turbine cluster thereby to reduce the wake effect of the first wind turbine cluster on the second wind turbine cluster.

13. The controller of claim 12, where the first wind turbine cluster has a characteristic cluster size, which is a maximum distance between any two wind turbines in the first wind turbine cluster when taken in a direction that is aligned with the direction between first and second wind turbine clusters.

14. The controller of claim 13, wherein the second wind turbine cluster is separated from the first wind turbine cluster by a distance that is greater than a maximum turbine separation distance, preferably greater than 150% of the maximum separation distance, and preferably more than 200% of the maximum separation distance.

15. A method for controlling a first wind turbine cluster, comprising:
quantifying a wake effect of the first wind turbine cluster on the operational performance of a second wind turbine cluster; and
responsive to identifying a triggering condition based on the quantified wake effect, controlling one or more operational parameters of the wind turbines in the first wind turbine cluster to improve the wake recovery of the first wind turbine cluster;
wherein the first wind turbine cluster has a characteristic cluster size, which is a maximum distance between any two wind turbines in the first wind turbine cluster when taken in a direction that is aligned with the direction between first and second wind turbine clusters;
wherein quantifying the wake effect includes modelling the wake effect of the first wind turbine cluster on the second wind turbine cluster based on one or more wind flow conditions associated with the first wind turbine cluster.

16. The method of claim 15, wherein the one or more operational parameters include a yaw angle setpoint.

17. The method of claim 15, wherein the one or more operational parameters include an induction factor setpoint.

18. The method of claim 15, wherein the one or more operational parameters are dynamically varying.
